(19) United States
(12) Patent Application Publication
(10) Pub. No.: US 2012/0311445 A1
(43) Pub. Date: Dec. 6, 2012

(54) ENHANCED MEDIA RECORDINGS AND PLAYBACK

(75) Inventors: J. Alexander Cabanilla, New York, NY (US); Jonathan Sheldrick, New York, NY (US); Robert Taub, Princeton, NJ (US)

(73) Assignee: MuseAmi, Inc., Princeton, NJ (US)

(21) Appl. No.: 13/489,393

(22) Filed: Jun. 5, 2012

Related U.S. Application Data
(60) Provisional application No. 61/493,476, filed on Jun. 5, 2011.

(51) Int. Cl. G06F 3/01

(52) U.S. Cl. 715/716

(57) ABSTRACT

Enhanced features are provided by enhanced feature data stored with an enhanced media file in a conventional media container format. The enhanced feature data is not recognized by a conventional playback application, which produces the conventional playback experience of the media file for a user who lacks a suitably configured enhanced media file application. The enhanced feature data is recognized by a suitably configured enhanced media file application, which processes the enhanced feature data and responds to user inputs to support the enhanced user features and interaction in conjunction with playback of the enhanced media file.

### CROSS-REFERENCE TO RELATED APPLICATION

This application claims the benefit of priority of co-pending U.S. Provisional Patent Application Ser. No. 61/493,476 entitled “Enhanced Media Recordings and Playback” to J. Alexander Cabanilla, Jonathan Sheldrick, Robert Taub filed Jun. 5, 2011. Priority of the filing date of Jun. 5, 2011 is hereby claimed, and the disclosure of the Provisional Patent Application is hereby incorporated by reference.

### BACKGROUND

Listening to recorded programming, such as music, is immensely popular with consumers and can be quite lucrative for recording artists and the companies that distribute their works. For example, millions of copies of recorded songs are purchased daily, in both hard copy and electronic formats. Hard copy sales of media recordings include sales of vinyl records and optical discs such as Compact Disc (CD), Digital Video Disc (DVD), or Blu-Ray Disc (BD). Electronic formats include, for example, MP3, MPEG4, and AAC files that are downloaded via services such as “iTunes” and “Amazon” online retailers. The recorded programming may include audio songs and multimedia files recorded onto the hard copy recordings or in the electronic formats. For example, songs may be recorded in tracks of the record or optical disc. Multimedia files may comprise movies, television shows, music videos, games, and the like, recorded in chapters of the multimedia file. Playback of the recorded programming requires a player that is compatible with the format of the purchased copy. Most sales of hard copy, and all sales of electronic format media, are of digitally encoded representations of the original work.

Growth in sales of recorded programming has been problematic for over twenty years, after many years of continuously increasing sales. Interest in recorded programming could be increased if the playback experience could be more interactive and engaging for the listener. Stereo recordings, with a separate left audio channel and separate right audio channel, have been in use since the early twentieth century. Playback of recorded audio in electronic format is achieved with computer processors that execute playback applications, and are typically incorporated into devices such as desktop and laptop computers, mobile telephones, portable players, and tablet computers.

A recorded program, such as a multimedia file, may include songs, spoken word recordings, movies, television shows, and the like. Many computer playback applications, for example, permit display of data related to the work, such as song title, artist, year of recording, lyrics, genre, user rating, and the like. Such related data is generally referred to as metadata, and is stored electronically with the recorded programming itself, but does not form part of the work itself. The metadata may be included with the work as provided to the user, or some or all of the metadata may be supplied by the user through a suitable user interface, to be associated with the work. The metadata can add to the enjoyment of the audio work during playback and can increase convenience and user enjoyment of the user's library of works. The work itself, and/or parts of it, may be obtained online over a network via a server for playback, as per streaming and cloud-based applications, or may be obtained from a physical copy, such as from CD, DVD, or BD.

The conventional forms of metadata are somewhat limiting, being generally confined to text data such as artist, title, lyrics, and the like, and graphics data such as album artwork. Such types of metadata are generally adequate for relatively passive enjoyment of recorded programming, but a more interactive experience during playback would increase user enjoyment.

### SUMMARY

Disclosed are enhanced features that support user interaction not otherwise available with a recorded multimedia file comprising an enhanced media file. The enhanced media file is provided such that a suitably configured enhanced media file application can activate the enhanced user features, and such that a conventional playback application can support playback of the enhanced media file, though without the enhanced user features. That is, the enhanced media file is provided in a conventional media container format that can be recognized by a conventional playback application. Therefore, the enhanced media file is backwards-compatible with conventional playback devices for listening and viewing, whereas suitably configured enhanced media file applications can support the enhanced user features. The enhanced user features are provided by feature data stored with the enhanced media file in a conventional media container format. The feature data is not recognized by a conventional playback application and is ignored by a conventional player, which produces the conventional playback experience of the media file for a user who lacks the suitably configured enhanced media file application. The feature data is recognized by the suitably configured enhanced media file application, which processes the feature data and responds to user inputs to support the enhanced user features and user interaction, in conjunction with processing of the recorded programming.

The conventional media container format may comprise, for example, the “m4a” audio file format or “mp3” audio file format, or any other suitable file configuration, including multimedia or video formats such as the “mp4” format. Both m4a and mp3 formats are currently used for audio files with the “iTunes” playback application by Apple Inc. of Cupertino, Calif., USA. The m4a file format includes standard channels of data for left and right audio tracks as well as m4a metadata for track information such as artist, title, album, artwork, lyrics, and the like. The feature data described herein is proprietary to the suitably configured enhanced media file application and is stored in additional channels of data reserved in the audio file format for metadata. The feature data is preferably encrypted so that only the suitably configured enhanced media file application can utilize the proprietary feature data and produce the enhanced user features. The encrypted feature data cannot be read by non-configured playback applications, which read the conventional standard channels of data for conventional audio playback. Even if the feature data can be accessed by a device playback application, the accessed data would not be recognized by the playback application and generally would be ignored by the playback application, which would continue with processing of the conventional data for the work. In this way, the enhanced media file can be used with non-configured playback applications for a conventional playback experience, and can be used with suitably configured enhanced media file applications to support the enhanced user features.

Other features and advantages of the present invention should be apparent from the following description of preferred embodiments that illustrate, by way of example, the principles of the invention.

### BRIEF DESCRIPTION OF THE DRAWINGS

FIG. 1 is a representation of a tablet computer device with a display that shows a user interface for a conventional media file playback application executing on the device.

FIG. 2 is a representation of the table computer device with the display that shows a user interface track menu screen of an enhanced media file application as disclosed herein, executing on the device, and illustrating file controls in a portrait orientation of the device.

FIG. 3 is a representation of the tablet computer device with a display of the enhanced media file application that shows a user interface with a dialogue box for appending user data to an enhanced media file.

FIG. 4 is a representation of the table computer device with a display of the enhanced media file application that shows a user interface for an appended track selection menu screen.

FIG. 5 is a representation of the table computer device with a display of the enhanced media file application that shows a user interface for an enhanced media file playback application as disclosed herein, illustrating lyric and sound adjustment controls in a landscape orientation of the device.

FIG. 6 is a representation of the table computer device with a display of the enhanced media file application that shows a user interface for a track selection screen, also referred to as a home screen display.

FIG. 7 is a schematic representation of creating an enhanced media file with features as disclosed herein.

FIG. 8 is a block diagram that illustrates playback of an enhanced media file by a conventional media player.

FIG. 9 is a block diagram that illustrates playback of a conventional media file of recorded programming by an enhanced media file application.

FIG. 10 is a block diagram that illustrates processing of an enhanced media file by the enhanced media file application.

FIG. 11 shows an example of an enhanced media file upon playback and illustrates the enhanced user features that are available during processing of the enhanced media file.

FIG. 12 is a block diagram of a device with a suitably configured enhanced media file application for support of the enhanced user features during processing.

FIG. 13 is a flow diagram of device operations for providing the enhanced user features in conjunction with processing of an enhanced media file as discussed herein.

### DETAILED DESCRIPTION

The enhanced media file application disclosed herein extends the passive media playback experience into a more participatory interactive experience. This goal is realized with an enhanced media file that includes multiple media tracks (also called “stems”) in conjunction with proprietary processing that provides the enhanced user features. As used herein, a CD album will be understood to include multiple album tracks, also called songs, and a DVD or BD multimedia file will be understood to include multiple chapters, also called movie segments. A single album track or multimedia chapter may include multiple tracks or stems of data, such as multiple audio tracks, video tracks, and data tracks, which will be interchangeably referred to as audio stems, video stems, and data stems, respectively. All of these types of stems comprise a portion of a single enhanced media file. An enhanced media file may include multiple stems of a stem type. For example, the audio stems of an enhanced media file may include a vocal stem and an instrumental (music) stem. Further enhancements may involve combination of the above enhanced features in an interactive manner. For example, the interactive combination may provide a game experience, such as a karaoke game. The enhanced media file includes data sufficient to provide the features described herein, included in a conventional media file container such that the container is compatible with conventional media players, such as the “iTunes” player from Apple, Inc. of Cupertino, Calif., USA that plays files with an “m4a” suffix. A conventional media player can play conventional media files with the m4a suffix, and will be able to play the non-enhanced portion of an enhanced media file without difficulty, but will ignore the feature data comprising the enhanced portion of the enhanced media file, which will be contained within the file having the m4a suffix (or other file suffix, depending on the user preference). Other types of file containers may also be used, including file formats specified with a different file suffix, such as MP3, WAV, MPEG-4, and QuickTime (video). Such alternative file containers permit playback of the enhanced media file by both conventional playback applications and the disclosed enhanced media file application, though the enhanced user features are only available with the disclosed proprietary processing of an enhanced media file application.

The enhanced media file application disclosed herein is installed on a host device. As described further below, the host device may comprise a variety of computing platforms. The host device may also host additional multimedia applications, including conventional multimedia players such as the “iTunes” application by Apple, Inc. and the “Windows Media Player” by Microsoft Corporation of Redmond, Wash., USA. Because the conventional media player does not have the functionality to produce the enhanced user features upon playback of an enhanced media file, the conventional media player will provide a conventional user experience upon playing the enhanced media file. When the enhanced media file is played by a player enabled with the needed proprietary processing disclosed herein, the enabled player will produce the enhanced user experience with the enhanced user features described further below.

The enhanced media file application may utilize resources of the host device to reproduce audio and video output data of the enhanced media file. Such resources, for example, may comprise various codecs and processors of the operating system that is installed on the host device. Those skilled in the art will understand how applications such as the enhanced media file application may call for and utilize such system resources. The enhanced media file application may itself include codecs, processors, and other resources as needed for providing the enhanced features and for providing reproduction of the audio and video output of the enhanced media file. As disclosed herein, the audio and video stems of the album tracks and video chapters in the enhanced media file may be common to the enhanced media file and a corresponding “conventional version” of the conventional recorded programming. A conventional playback application on the host device may utilize resources of the host device to reproduce audio and video output data of the conventional recorded programming. If the conventional playback application is selected for playback of an enhanced media file, then the conventional playback application will process only audio and video stems of the album tracks and video chapters in the enhanced media file that can be processed by the conventional playback application.

Using a well-known file format such as the m4a format as an identifier of the enhanced media file is convenient, as the format is popular and file tools are readily available. For example, an iTunes m4a audio file may be constructed using standard tools available in the “Mac OS X” operating system available from Apple Inc. Other third-party tools are readily available for reading, parsing, and setting metadata into MPEG-4 files and, in particular, into m4a format files. One such tool, for example, is the freeware “atomicparsely” tool, which can be used for editing metadata. Those skilled in the art will be familiar with alternative tools for producing files of the proper format and for editing metadata associated with such files. As noted above, alternative file formats may be utilized as the identifier of the enhanced media file.

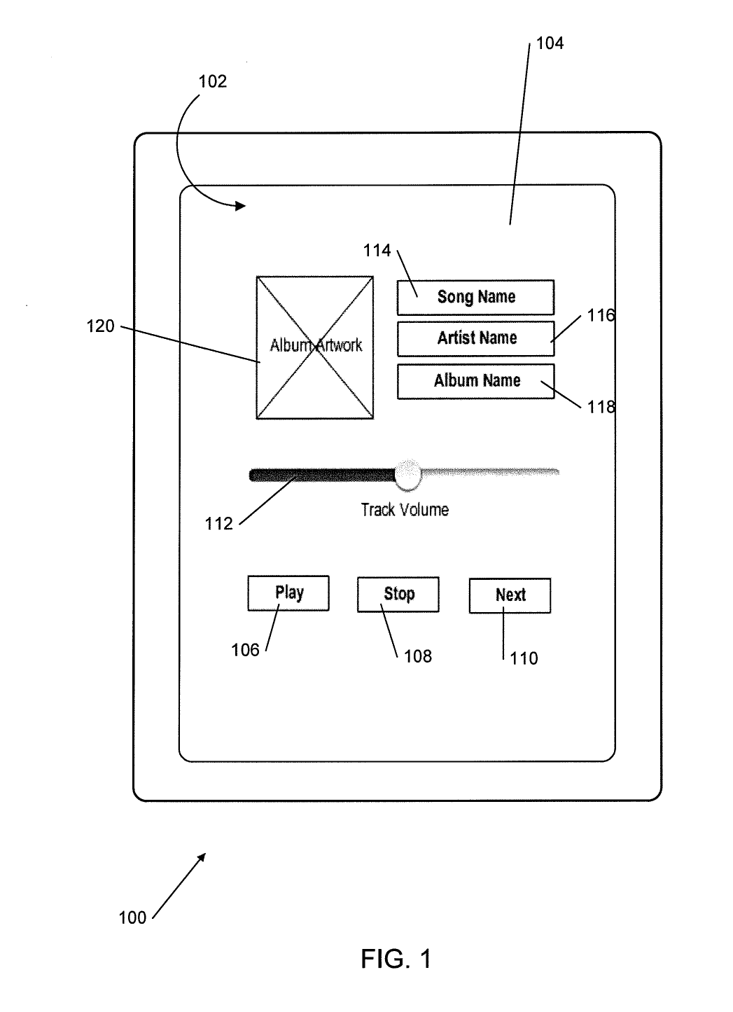

FIG. 1 shows a tablet computer device 100 on which are installed a conventional playback application and an enhanced media file playback application as disclosed herein. The tablet computer device 100 may comprise a device such as an “iPad” tablet computer available from Apple Inc. of Cupertino, Calif., USA or may comprise a device such as the “Galaxy Tab” tablet computer available from Samsung Electronics Co. Ltd. of Seoul, South Korea. The tablet computer device has a substantially planar shape that includes a display 102. The display of FIG. 1 shows a user interface window 104 of a conventional playback application that is installed on the device and is executed by a device processor. The display 102 provides a touchscreen interface such that symbols of the user interface window may be selected by user touch, in response to which the tablet device performs playback of a multimedia file. The bottom of the illustrated user interface window 104 includes playback controls comprising a “Play” display button 106 that is selected to initiate playback of a file, a “Stop” button 108 that is selected to halt playback, and a “Next” button 110 to select a next file or track in a playlist or library of tracks. The user interface window 104 also includes a slider volume control 112 that may be moved to continuously adjust playback volume level. The top of the user interface window shows a symbol or text of the song name or track title 114 for the file being played, the artist name 116 for the file, and the album or collective work name 118 for the file, as well as cover art or other graphics image 120 associated with the file.

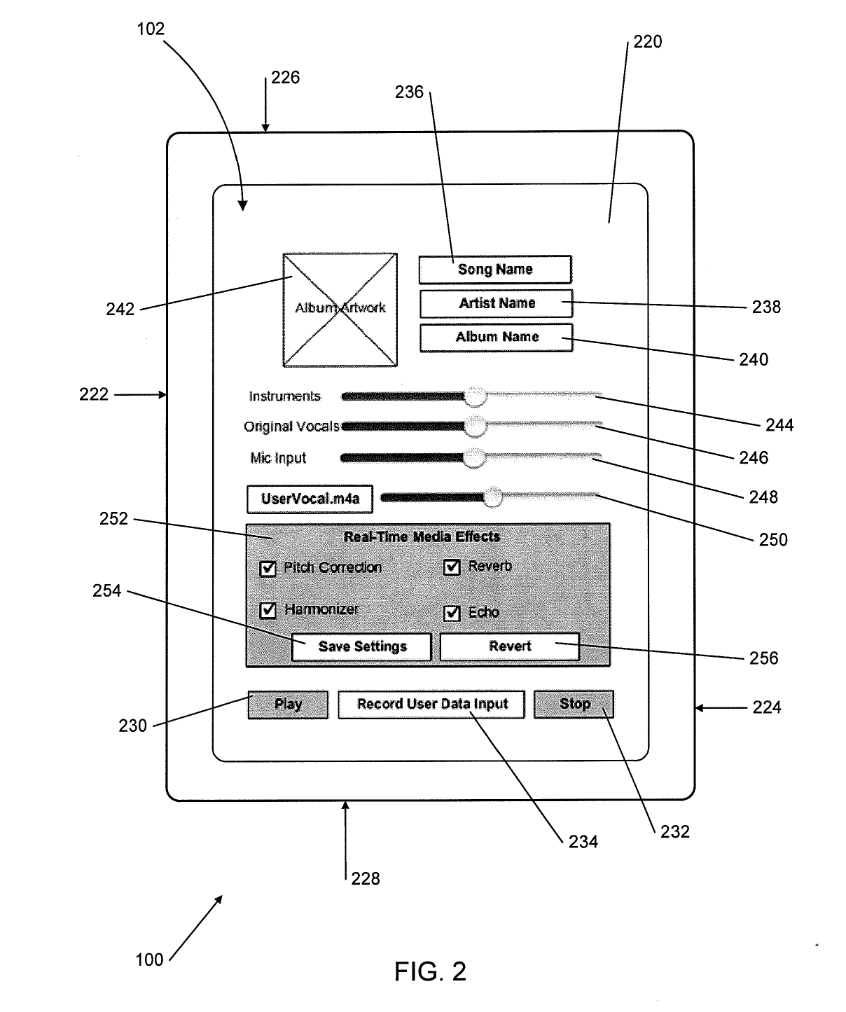

FIG. 2 shows the tablet computer device 100 with the display 102, on which is shown a user interface track menu screen 220 of an enhanced media file application as disclosed herein. The enhanced media file application is executed by a processor of the device 100. The device has two parallel longer left and right sides 222 and 224, respectively, and has two parallel shorter top and bottom sides 226 and 228, respectively. Thus, the device is illustrated in FIG. 2 in an orientation commonly referred to as a portrait orientation. The bottom of the illustrated user interface screen 220 shows playback controls comprising a “Play” display button 230 that is selected to initiate playback of an enhanced media file as disclosed herein. The user interface window for the enhanced media file application includes a “Stop” button 232 that is selected to halt playback, and a “Record User Data Input” button 234 that is used to initiate recording user data input, such as user input from a microphone or selected file. The “Record User Data Input” button 234 is useful, for example, in recording a sing-along vocal contribution or other performance of a user, as described in greater detail below. The top of the user interface track menu screen 220 shows a symbol or text of the song name or track title 236 for the enhanced media file being played, the artist name 238 for the file, and the album or collective work name 240 for the file, as well as cover art or other graphics image 242 associated with the file. As noted previously, a single enhanced media file may comprise a number of independent multimedia files grouped into a collective work called an “album” or “movie” and the grouped independent multimedia files may include multiple album tracks or movie chapters.

The track menu screen 220 also includes volume adjustment controls. In the FIG. 2 embodiment, the volume adjustment controls are provided as slider controls for the touchscreen interface. Other configurations of controls for adjusting playback volume may be used, as will be apparent to those skilled in the art. Two of the slider volume controls comprise a control 244 for “Instruments” playback level and a control 246 for “Original Vocals” playback level. Another volume control 248 is for “Mic Input” to permit adjustment of a microphone level during recording, as described further below. Also provided in the track menu screen 220 is a volume control 250 for adjusting the volume level of “User Vocal” data retrieved from an audio file, to be integrated with the existing enhanced media file, as described further below. Thus, the enhanced media file application supports the features of independently adjusting relative level of instruments and original vocals during playback, and integrating microphone input with the stems of tracks and chapters of the enhanced media file during playback, and also integrating audio input from an audio file with the stems of tracks and chapters of the enhanced media file during playback.

In FIG. 2, the two playback volume controls for Instruments 244 and Original Vocals 246 are shown adjacent each other in the track menu screen 220, to facilitate moving them together simultaneously in unison with a single selection and swipe or slide motion by a user, but these controls may also be moved independently of each other, as desired. When moved together in unison, the Instruments and Original Vocals controls will maintain the relative volume of the instrumental portion (i.e., music stem) and original vocal portion (i.e., vocal stem) of an enhanced media file at substantially equal levels as compared to the initial levels of the instrumental and vocals portions of the file.

The track menu screen 220 of FIG. 2 shows a display area 252 that includes controls for real-time media effects. The media effects may be applied to the stems of tracks or may be applied to the stems of chapters of the enhanced media file, and/or may be applied to user data input comprising a user accompaniment to be combined with the stems of tracks or chapters of the enhanced media file, and/or may be applied to user data input comprising media effects settings to be applied to an enhanced media file that may include a recorded user accompaniment. The media effects are applied during processing of the enhanced media file so as to alter the output of the enhanced media file application from what the output otherwise would be, and to provide the user with an experience of the media effects being applied simultaneously with the user providing or specifying the media effects. That is, the real-time media effects enable the user to provide input, for example an accompanying vocal contribution, such that the user's vocal contribution is combined with the stems of tracks or chapters of the enhanced media file and the user experiences both simultaneously, and the real-time media effects also enable the user to provide input, for example settings for pitch, reverb, echo, and/or harmonization, such that the settings are applied to the enhanced media file comprising the stems or chapters and any recorded user input such as a vocal contribution. In this way, the user can combine the user's vocal contribution with recorded audio and/or video data in an accompaniment mode such as karaoke, and the user also can apply media effects settings interactively to a recorded karaoke performance. The user data input may comprise, for example, data from an audio capture device such as a microphone. Control of the microphone level may adjusted by the volume slider 248. The real-time media effects may be selected singly or combined together, for application to, or mixing with, the data stems of album tracks or multimedia chapters of the enhanced media file and/or user data input. In this way, it is possible to produce unusual and heretofore unknown effects by mixing the real-time media effects. The real-time application of media effects provides substantially instantaneous experience of the selected media effects. The media effects may include audio changes, video changes, or both.

FIG. 2 shows the display area 252 with effects controls for selection of effects from the user interface of the track menu screen 220 by a check box or other suitable means of indicating selection of a media effect by the user. The media effects illustrated in FIG. 2 include, for example, audio changes such as pitch correction, reverberation, harmonizer, and echo. Each of the effects may be selected to be turned on or applied, as with a checked checkbox, or each effect may be turned off, as with an unchecked checkbox. As noted above, checking multiple checkboxes will simultaneously apply the corresponding checked effects. Additional audio and/or video effects may be offered for user selection in the display area 252 as desired. For example, the real-time media effects may include: pitch changes such as pitch correction and harmonization; timbral changes such as voice-to-MIDI conversion and voice-to-synthesizer conversion; rhythmic changes such as time stretching and beat splicing; sonic characteristics such as reverberation, echo, tremolo, ring modulator, flanger, chorus, bit crusher, and auto-wah, as well as audio speed or rhythm; and video effects such as video brightness and video color saturation. Other audio and video effects will occur to those skilled in the art. The enhanced media file application will include processing that will receive the user selection from the FIG. 2 interface and will perform the processing called for by the selected effect or effects. Such processing may be controlled or adjusted by parameters that are included in the metadata of the enhanced media file. The enhanced media file application may utilize system resources of the host device in performing the processing.

For example, with respect to the harmonization effect, the actual amount or type of harmonization applied to a user's voice or other input may be dictated by the metadata contained in the enhanced media file. The processing of the enhanced media file application in connection with the real-time media effects, such as harmonization, can be configured by the metadata, and then the processing can be further adjusted by the user if the enhanced media file application and if the user interface and system resources of the host device allow for it. A developer of the enhanced media file application may determine the extent of user control that will be supported by the enhanced media file application. In general, the “harmonizer” effect will receive the user input during playback of a track or chapter of the enhanced media file to which the user is providing accompaniment, such as singing along or performing, and will attempt to modify the user input so as to complement, or harmonize with, the key and scale of the track or chapter to which the user is providing accompaniment. Such accompaniment can be saved with the enhanced media file and listened to upon playback. As described further below, multiple user contributions may be saved with an enhanced media file, if desired. Thus, the harmonizer effect can be used create an effect of multiple instances of the user's voice singing in harmony with the track or chapter.

The amounts of the real-time media effects may be controlled by a default setting found in the configuration/automation files of the metadata. The default setting may be set at an effect level that is determined by the content provider of the enhanced media file. In an alternative scheme, the enhanced media file application may provide the user of the application with a control to adjust the amount of real-time media effect to their liking, different from or in place of the default setting from the content provider. This user-controlled scheme may be implemented with controls that are similar in concept to a multi-band filter, e.g. a filter that adjusts treble, bass, and the like, and with which most users are familiar. With the user-controlled scheme, it would be possible for the user to save the changed amount of real-time media effects in the user data section of the enhanced media file. The enhanced media file application may also support having both scenarios (default settings and user-controlled settings) as options available to the user.

Similar control schemes may apply to the other real-time media effects settings. For example, the settings for the echo effect illustrated in FIG. 2 may be determined by the metadata in the enhanced media file according to default levels, but those echo settings could potentially be adjusted by the user if the application and the system resource user interface support such adjustments.

In addition, the real-time media effects may be toggled on and off. For example, by tapping one of the effect buttons (e.g., echo, harmonizer, and the like) shown in FIG. 2, the corresponding effect button may be illuminated or highlighted and the corresponding effect will be activated. If the effect button is tapped again, the corresponding real-time media effect button reverts back to its original visual state, and the corresponding real-time media effect is deactivated, or turned off.

Some of the real-time media effects may be controlled solely by the content provider data that is in the configuration or automation files of the metadata. The data for such effects may be adjusted in real-time during playback by the application, as directed by the content provider data, with specific time-on and time-off values as a function of the elapsed playback time of the enhanced media file. Such effects control levels need not be simply “on” or “off” times, but may also be a predetermined numerical value or magnitude (i.e., real-valued or enumerated) that is defined over a designated value range appropriate for the real-time media effect being controlled. As noted above, the enhanced media file application may provide alternate controls for other effects or may override the content provider default settings. This feature allows a user to turn the real-time media effects on and off, or adjust the parameter value, in real-time.

When the real-time media effect is applied during playback of an album track or multimedia chapter, the user has the option of saving the media effect settings or removing them and reverting to the original enhanced media file as it was prior to the application of the media effects. The user selects between these two options by selecting a display button in the display area 252, either a “Save Settings” button 254 or a “Revert” button 256. When the settings are saved, data corresponding to the settings are saved with the enhanced media file, such that the enhanced media file application overwrites the original enhanced media file with a version of the enhanced media file that includes the saved settings. The overwriting operation may involve overwriting only the user data portions of the enhanced media file having the effect data, with no change to the original stems of the track or chapter, which remain unchanged. In FIG. 2, the “Revert” button 256 may be selected to cancel saving of real-time media effects, or “Revert” may be selected upon playback of an enhanced media file that includes saved real-time vocal effects, to cancel application of the saved vocal effects during the current playback of the enhanced media file.

Thus, the Save Settings button 254 applies the media effects to the enhanced media file by appending data indicating the applied media effects to the enhanced media file. The appended data may be stored, for example, as an additional track of data, stored in parallel to the associated prior tracks of the affected album track or multimedia chapter. When an enhanced multimedia file with appended media affects is processed for playback, the enhanced media file application detects the appended settings data, determines the media effects specified by the data stored in the data track, and applies the specified media effects to the album track or multimedia chapter.

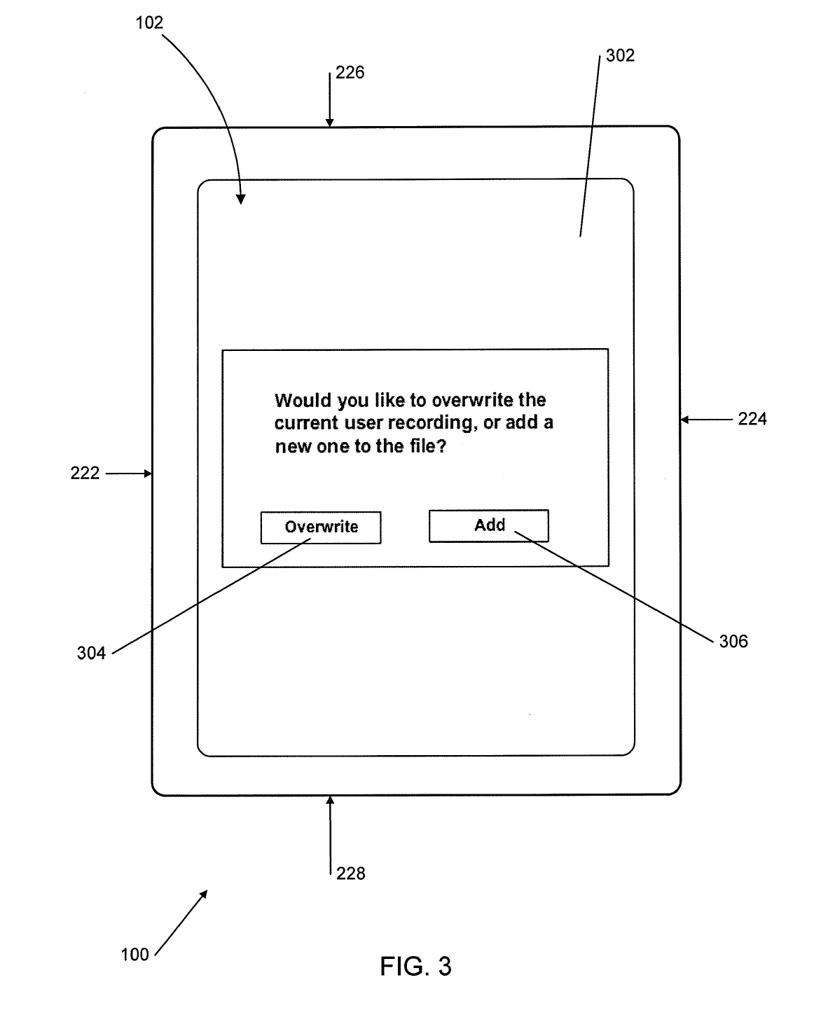

As noted above, if the “Record User Data Input” button 234 is selected in the track menu screen 220, the enhanced media file application responds by initiating a sing-along or accompaniment operating mode, such as a Karaoke operation, in which user input is received via a microphone input. Further in response to the “Record User Data Input” instruction, the enhanced media file application generates a user data input dialogue box to show a query and receive user preference as to replacing a previously recorded stem or track of user input, or adding the user input to the enhanced media file without replacement. The user interface for this feature is illustrated in FIG. 3.

FIG. 3 shows a user data input dialogue box 302 on the display 102. The dialogue box 302 includes two input buttons for responding to the query as to user preference, an “Overwrite” button 304 if the user wants the current microphone input to overwrite a prior recorded stem or track, and an “Add” button 306 if the user wants to append the current microphone input as an additional stem to any prior tracks (recordings) of microphone input for the current album track or movie chapter. In the case of an overwrite instruction, the enhanced media file application may, for example, replace the last-recorded accompaniment track with the current track, or the application may replace the earliest-recorded (oldest) accompaniment track with the current track, or a menu selection may be provided for user selection of replacement.

As noted above, the track menu screen 220 (FIG. 2) includes a “Play” button 230 for initiating processing of an enhanced media file that produces playback output. If the enhanced media file selected includes appended user input stems or tracks, such as recorded user data input, then the enhanced media file application detects the presence of the appended user input data, and displays an appended track selection menu screen for the user to select a desired one of the appended user data input.

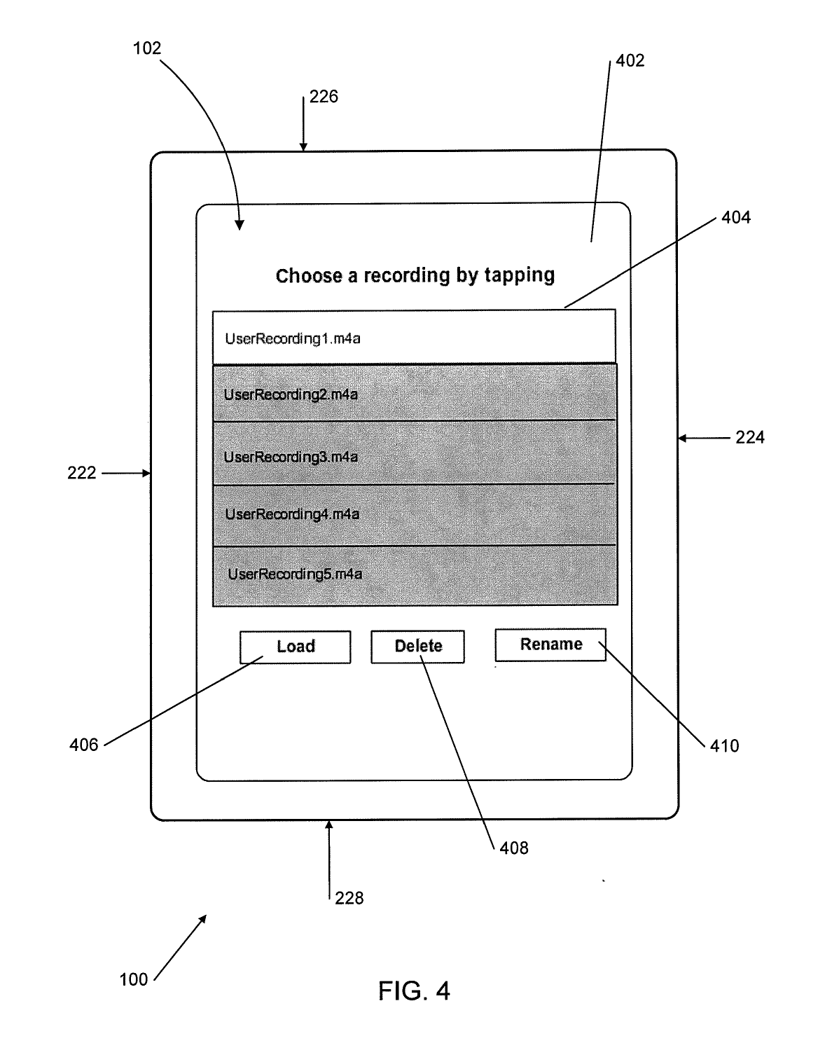

FIG. 4 shows an appended track selection menu screen 402 on the display 102. The screen 402 shows a list 404 of user input stems or tracks that are stored with an association to the selected enhanced media file. The user selects a desired user input track for playback simultaneously with the original recorded album track or movie chapter by selecting the desired user input from the list 404, such as by touchscreen input or cursor selection. On the display screen 402, beneath the list of user input tracks, FIG. 4 shows selectable actions indicated by buttons including a “Load” button 406, a “Delete” button 408, and a “Rename” button 410. The Load button retrieves the selected user input track for playback so that the user experiences the selected track simultaneously with the other data in the associated enhanced media file. For example, if the selected user input is an audio track, and if the user selected the user input via the Load button 406, then the enhanced media file application will play the user's audio contribution from the user input track simultaneously with any audio tracks of the original album track or movie chapter. The Delete button 408 permits the user to delete the selected user input track from the list 404 of appended user tracks, and the Rename button 410 permits the user to rename the selected user input track via a rename dialogue box (not shown).

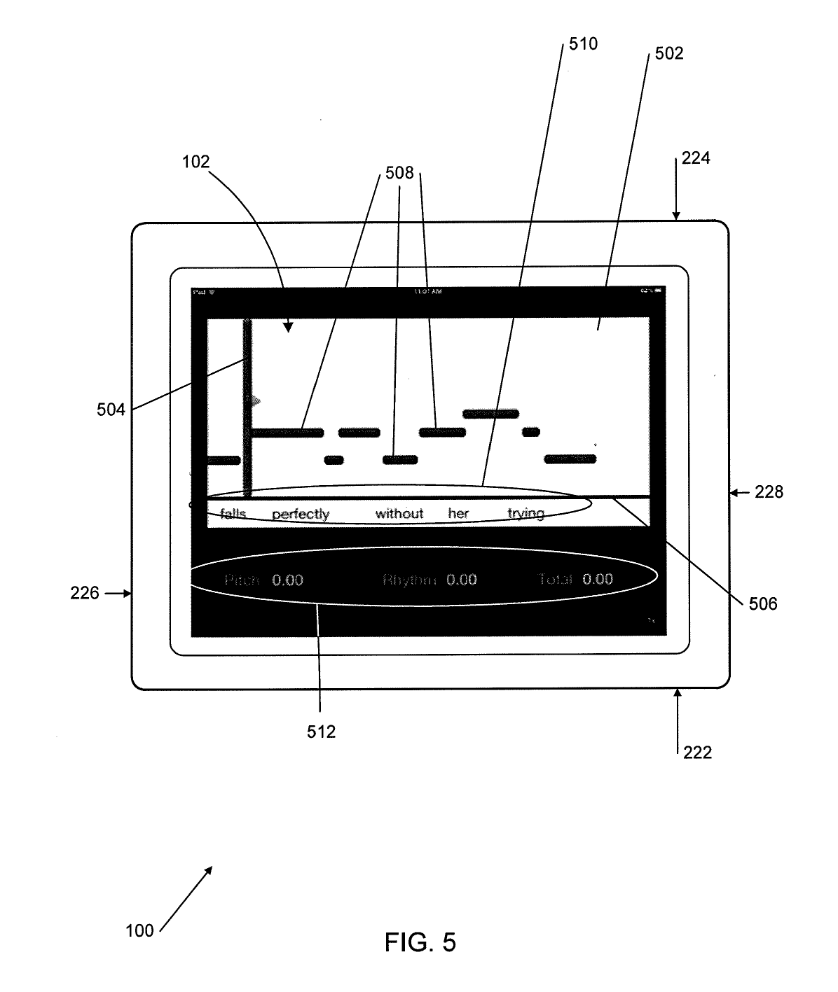

FIG. 5 shows the device 100 in a landscape orientation, with the longer sides 222, 224 of the device oriented horizontally and the shorter sides 226, 228 oriented vertically. When the device is oriented in landscape, the enhanced media file application changes the display 102 to show a track information screen 502. The enhanced media file application can detect the change in device orientation using device resources, such as a device accelerometer and the like. In the track information screen, an upper portion of the screen provides note information with a fixed vertical axis 504 to show tonal pitch and a scrolling horizontal axis 506 to show elapsed time. During playback of an album track or movie chapter, the elapsed time value on the horizontal axis 506 begins at time zero and increments as the playback continues, updating the elapsed time so that current time of playback appears approximately at the intersection with the vertical axis 504. In the note information portion of the screen display 502, musical note indicators appear from the right side of the display 102 corresponding to note values along the pitch axis 504, the musical note indicators scrolling across the display from right to left as the playback continues. In FIG. 5, only three exemplary musical note indicators 508 are identified, but it should be understood that each of the similarly shaped horizontal bars in the drawing are also musical note indicators. The horizontal extent of the musical note indicators correspond to the relative note duration for the pitch indicated. Lyrics, if any, for the album track or movie chapter, are shown during playback at a location below the time axis 506, as indicated generally by the ellipse 510. The lyrics scroll across the display 102, approximately beneath their corresponding occurrence in the elapsed time.

In an assessment portion of the track information screen 502, assessment ratings are displayed, indicated generally by the ellipse 512. In FIG. 5, the assessment ratings include a Pitch score value, a Rhythm score value, and a Total score value. The respective score values are determined during an accompaniment mode of operation for the enhanced media file application, also referred to as a “sing-along” or “Karaoke” mode. During the accompaniment mode, the processor of the device 100 monitors input from an audio capture device, such as a microphone, during playback of the album track or movie chapter, and compares the microphone input to the corresponding “target” pitch and rhythm as exemplified by the original soundtrack or vocal track of the enhanced media file. In this way, a user can sing lyrics into a microphone while an instrumental track plays, and the enhanced media file application will assess how closely the user's vocal contribution of singing is to the original recording, in terms of pitch and rhythm. The user's vocal contribution may be produced as output of the enhanced media file application either in addition to or in place of a vocal stem of the underlying original recorded programming. The assessment ratings may be updated in real time. Parameters of a user's input may be assessed, in addition to or in place of pitch and rhythm, according to the configuration of the enhanced media file application.

The operation of the enhanced features described above is initiated by selection of an enhanced media file and playback of the selected file by the enhanced media file application disclosed herein. As noted above, an enhanced media file as disclosed herein has a file suffix that indicates a conventional file format, and reflects the file format with which the multimedia tracks were created. The exemplary files described herein have an “m4a” suffix. A conventional player that can process conventional media files of the suffix (e.g. m4a) can also process the enhanced media file, albeit without producing the enhanced features disclosed herein. To gain access to, and reproduce, the enhanced features from an enhanced media file, it is necessary to utilize the enhanced media file application disclosed herein. Therefore, the enhanced media file application provides a user interface for selection of an enhanced media file.

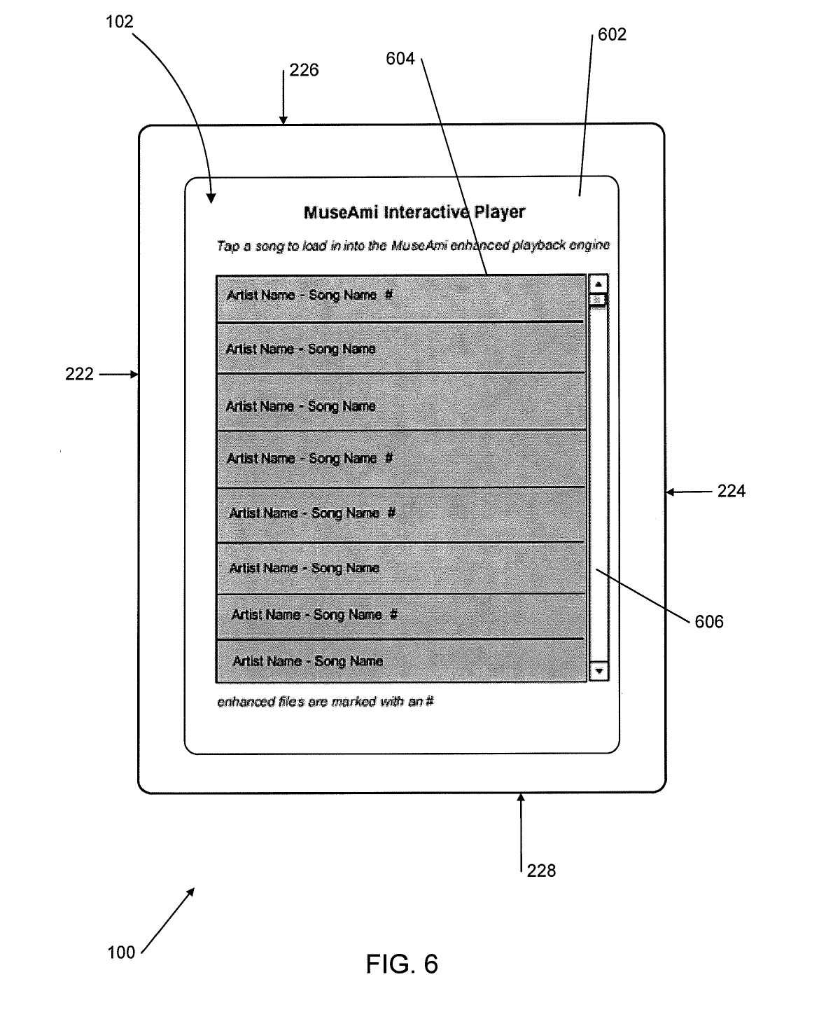

FIG. 6 shows the device 100 in a portrait orientation, with the display 102 showing a track selection screen 602, which is also referred to as a home screen display. The track selection screen 602 provides a listing of media files available to the device 100 and the enhanced media file application. When the enhanced media file application is launched, it automatically performs a search of available files to locate and identify enhanced media files. The extent of scan may cover a storage disk or storage area of the device, such as a hard drive or memory, or an attached device or mounted drive. When the available enhanced media files are located and identified, the application shows the track selection screen of FIG. 6.

The FIG. 6 track selection screen 602 shows a list 604 of available album tracks or movie chapters that may be processed by the enhanced media file application. The list 604 includes files having the file name suffix that may be processed by the enhanced media application. The list may include conventional media files for playback and also enhanced media files available for playback. For example, the list 604 shows the enhanced media files designated with a special symbol, show as “#” in FIG. 6, to distinguish them from the conventional media files. Other symbols or designations may be used to distinguish between conventional media files and enhanced media files. FIG. 6 shows the album tracks arranged in order of artist name and song name, but those skilled in the art will know of suitable alternative and supplemental characterizations with which the tracks may be identified. If the list includes more tracks than will fit on a single display screen, the information for the additional tracks may be viewed by moving up and down the list 604 using a scroll bar 606 of the user interface or cursor keys of the device 100.

The enhanced features disclosed above are made possible by enhanced media files, from which the enhanced features are produced by the enhanced media file application. Such enhanced media files are produced through a creation process that makes use of audio files and video (graphics) files that comprise audio and video tracks of the group work comprising an album or movie. The enhanced media file may comprise, for example, album tracks or movie chapters comprising tracks or chapters of a conventional audio or video (multimedia) work, supplemented with enhanced features such as those disclosed herein, including recorded user input, real-time vocal effects, and karaoke input and assessment. That is, the conventional audio or video work may be a commercially available recording that is separately available, whereas the present disclosure describes an enhanced version of the commercially available recording, having all the material available on the commercially available recording, and also having the enhanced features disclosed herein.

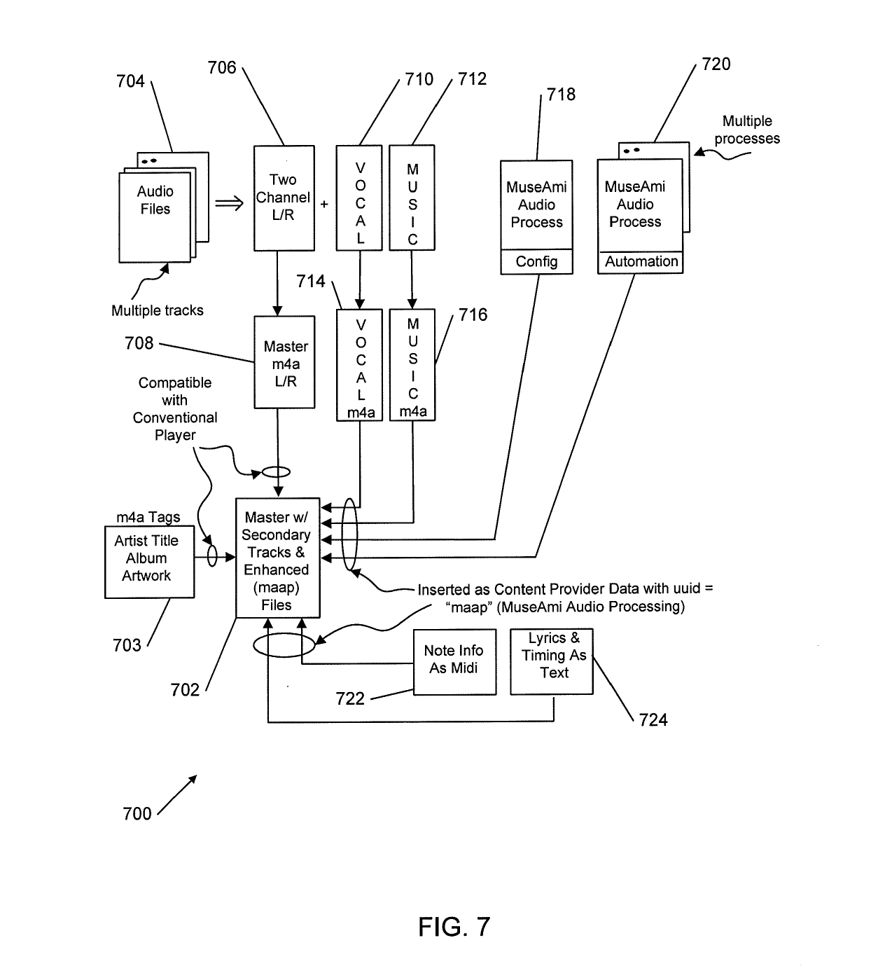

FIG. 7 illustrates a track creation process 700 for producing an enhanced media file 702 with enhanced user features as disclosed herein. FIG. 7 shows various components (some optional, as noted below) of an exemplary enhanced media file. In FIG. 7, only the audio data portions of the enhanced media file 702 will be described. It should be understood, however, that the enhanced media file 702 may include data types such as audio, video, graphic, and other data types, singly or in combination with one or more files of one or more of the data types included. For example, the enhanced media file 702 may include both audio data and video data.

The enhanced media file 702 illustrated in FIG. 7 comprises an album track that is produced from a number of files 704 that define audio tracks or stems. For a conventional audio file, a two-channel left and right track (L/R stereo) file 706 is created from source audio files, from which a master m4a stereo file can be created. This m4a stereo master is the conventional stereo music file that is commercially available to listeners, such as for programming recorded onto physical media such as CD, DVD, BD recordings or vinyl records, or such as electronic format programming available through online retail sales such as the Web site of Amazon.com, Inc. of Seattle, Wash., USA or such as the “iTunes Music Store” of Apple Inc.

Any number of tracks 704 using various channel layouts according to the file format being used can be encoded into the stereo master 708. In the m4a file format, channel layouts that are available from Apple Inc. are defined. These channel layouts include standard audio channel configurations, multichannel joint-surround encodings, and sequential encodings. The tracks to be encoded may be provided by the user, or by recording artists, media distributors, record labels, sponsors, and the like. Most recorded works are sourced from multiple tracks such as vocal and music (instrumental) tracks. The multiple tracks are mixed down during the mastering process and typically a final two-track (stereo) work is produced. The final work according to the file format can sometimes have a multiple number of tracks that are automatically mixed down by the playback application from the multiple tracks into two-channel (stereo) form for presentation to the listener. For example, the “iOS” platform operating system for mobile devices from Apple Inc. does not currently allow for direct access to individual tracks, but rather utilizes mixed-down stereo samples. Thus, it renders the various channel layouts available to m4a files as useless in the endeavor described herein. As a consequence, the conventional master stereo tracks are placed in their typical position in the enhanced media file 702 as would be expected by a conventional player application for a conventional media file. Additional information, such as m4a metadata tags 703, are also placed in their typical position in the enhanced media file as would be expected by a conventional player application. This arrangement supports backwards compatibility of the enhanced media file 702 with conventional playback devices.

FIG. 7 shows that the enhanced media file 702 is produced starting with the collection of audio files 704, two-channel L/R data file 706, and master m4a file 708 that are used for producing the conventional album track. As noted, the tracks of the master m4a file are placed in the enhanced media file 702 in locations corresponding to their typical position in the corresponding conventional commercially available album track.

All of the additional multimedia tracks and feature data that provide the enhanced features disclosed herein are appended to the user-data section of the m4a enhanced media file 702. Because of the additional data for the enhanced features, the enhanced media file is a larger file than would otherwise be needed for the data of a conventional file 708. The increased file size, however, is necessary for providing the enhanced features, and the additional data is not of a size that creates any significant problem or difficulty for processing by the device. It should be noted that the enhanced features as described herein could also be generated as described even with an operating system that grants full access to individual tracks of songs and movie chapters.

For providing further information regarding the m4a file format, it is noted that an m4a file is comprised of sections of information called “boxes” or formerly called atoms. Those skilled in the art will appreciate that there are a whole host of various boxes that are used for different purposes. For example, a section of information with user-defined data is a box with the designator “udta”. Found within the udta box is a user-extension box, having a “uuid” designator. The data in the uuid box is required to have a length value followed by the “uuid” designator. Additional designators may not be as clearly defined. For example, the “atomicparsely” tool mentioned above requires data comprising a four-byte designator from which a unique 16-byte universal id (unfortunately also referred to as uuid) is created, followed by the original four-byte designator and more formatting, and then the actual data payload. For the technique described herein, the four-byte designator “maap” was arbitrarily adopted. Those skilled in the art will understand that other designators may be selected, as desired. That is, the selection of a designator is at the discretion of the file developer and application developer. The “atomicparsely” tool uses the next 20 bytes of information for “encrypting” or “formatting” of the uuid box payload. That is, the tool accesses user data of data appended to the m4a file. The uuid boxes are marked with a four-letter identification code, “uuid”. The first chunk of data looked for during processing by the enhanced media file application is the properly created 16-byte uuid followed by the internally-used four-letter code “maap”.

The m4a file format specifies a section that can be included for user-supplied data. This user-supplied data section can have smaller subsections called uuid boxes that are marked with a four-letter identification code. As described above, for example, the present user features may be contained in an m4a file subsection indicated with the uuid of “maap” (for MuseAmi Audio Processing, wherein MuseAmi, Inc. is the assignee of the present invention). While some expected formatting of the user data section and uuid boxes is required (such as the aforementioned id code), the contents are not required to be formatted in any specific manner. This effectively provides an open channel to carry additional data that does not interfere with the conventional audio playback of the master two-channel m4a audio track within the enhanced media file, identified with the m4a suffix. That is, the master audio tracks of an enhanced media file song are encoded into an m4a file with the appropriate m4a tags for information such as the artist, song title, album title, and album artwork. This master m4a file serves as the container for all other user supplied data, including data for the enhanced features.

It should be understood that other file formats that contain media for playback will likely have corresponding file subsections for user data that can be utilized for containing data for the enhanced features described herein. Such file subsection configurations permit creation of enhanced media files in such other file formats using the same techniques described herein, and such enhanced media files in other file formats will also be backwards-compatible with conventional players for the respective file types. For example, file formats that are intended to be organized into user libraries may have user data sections suitable for storing library information and the like, which the present technique can utilize for storing data for the enhanced features described herein. It also is possible for the user to store their own metadata in the enhanced media file. For example, a user may purchase a multi-track file and create their own unique sound, including configuration or automation data. They could store their own interpretation in the same file alongside the original artist's version.

Additional vocal 710 and music (i.e., instrumental) 712 tracks can be used to produce corresponding respective vocal m4a tracks 714 and music (i.e., instrumental) m4a tracks 716. These vocal 714 and instrumental 716 tracks comprise secondary tracks with enhanced features, and can be any number or combination of multimedia tracks or stems. For supporting the enhanced user features and in the interest of backwards compatibility, two sets of stereo audio tracks are used in the enhanced media file 702: for example, instrumental music, and lead vocals. Each of these secondary tracks are encoded into binary files using standard iTunes m4a container files. Both binary files are injected into the user data section of the master m4a enhanced media file 702. Proprietary audio processing features available from MuseAmi, Inc. and associated effects modules for the enhanced experience are utilized. Configuration files 718 and, where appropriate, automation files 720, are tailored for the specific audio tracks layout, musical style, and entertainment goals of the enhanced media file.

The configuration files 718 provide a single overall data configuration and structure for the specification and support of complex media processing, including audio processing and video processing. A configuration file includes sections that control system-wide characteristics (such as sample rate and other system resource parameters), and also includes sections that list all of the processing components and modules in use, the layout of channel configurations, buffering requirements, the connections of components and processing modules in order to create a signal chain, the setting of any module parameters, the inclusion of automation files, connection points to analytics, as well as custom control points. The automation files 720 provide a mechanism to adjust any set of parameters for any number of software components and processing modules over a given time frame with a specified transition curve, e.g. step-wise, linear, parabolic, and the like.

Each of the configuration and/or automation files 718, 720 are sequentially injected into the user data section of the master m4a enhanced media file 702. For example, a metadata editor such as the aforementioned “atomicparsely” may be used to inject or insert the files into the user data section of the m4a file 702. Additional game-related support files such as note information in a MIDI file 722 and lyrics/timing information in a text file 724 can also be optionally injected into the content provider data area of the enhanced media file 702. The addition or insertion of the content provider data into the enhanced media file may be achieved with a metadata editor. The addition of such secondary tracks and of the enhanced features file into the uuid=“maap” content provider data section of the m4a file is indicated in FIG. 7 by the ellipse around data arrows leading into the enhanced media file 702.

Conventional playback of audio information and video information in the enhanced media file is available for playback through conventional playback applications, such as the “iTunes” player application available from Apple Inc. as well as other conventional media players. Because the basic file underlying the enhanced media file is a conventional iTunes m4a file having a recognized file suffix (i.e., m4a), the enhanced media file will be completely accepted and incorporated into a user's iTunes Music Library. The music library will be accessible via a conventional “iTunes” player installed on any “Mac” computer, “iPod” player, “iPhone” mobile telephone, or “iPad” tablet computer, or the like from Apple Inc. Furthermore, the music library will be accessible to any computer device such as a device with the “Windows” operating system from Microsoft Corporation of Redmond, Wash., USA installed with the “iTunes” player application for “Windows”. The music library may alternatively be available to other installed third-party media file players supported by the host operating system of the user device. Users can make use of the player application or other file exploring application to sort through available tracks, include tracks in playlists, or simply play the tracks back at their request. Similar features and capabilities and cross-platform compatibility of the m4a files can be provided with alternative file formats and playback applications, as will be known to those skilled in the art.

Additionally, a suitably configured enhanced media file application in accordance with this disclosure provides an iOS-compatible application that interfaces with the “iTunes” library or other user music library, and returns the same basic information about available audio files and requests any audio track to be played back as easily as through the standard “iTunes” Music Player application or other music player application installed on the device. The techniques described herein can be applied similarly to other operating systems and playback applications for mobile platforms and table computer devices, and for more sophisticated computer devices. The operating systems with which the suitably configured conventional playback application will execute may include, for example, operating systems such as the “Android” operating system from Google Inc. and “Windows Phone 7” operating system from Microsoft Corporation for mobile and table devices, as well as “Mac OS X” from Apple Inc. and “Windows” from Microsoft Corporation. Corresponding suitably configured playback applications may be provided for the respective operating systems.

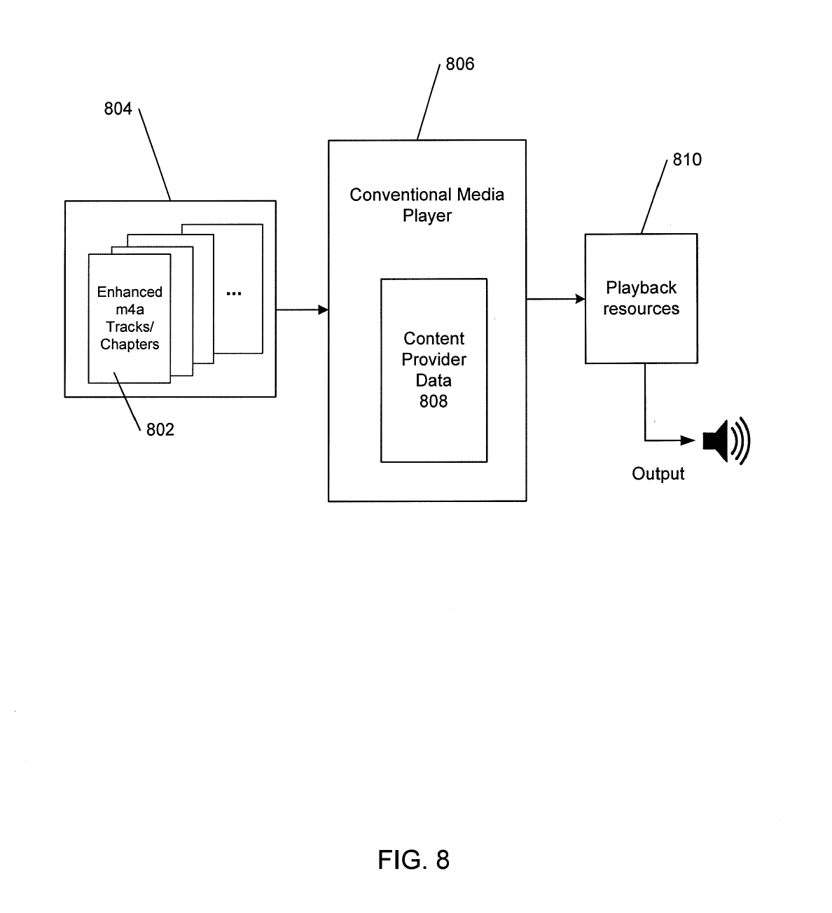

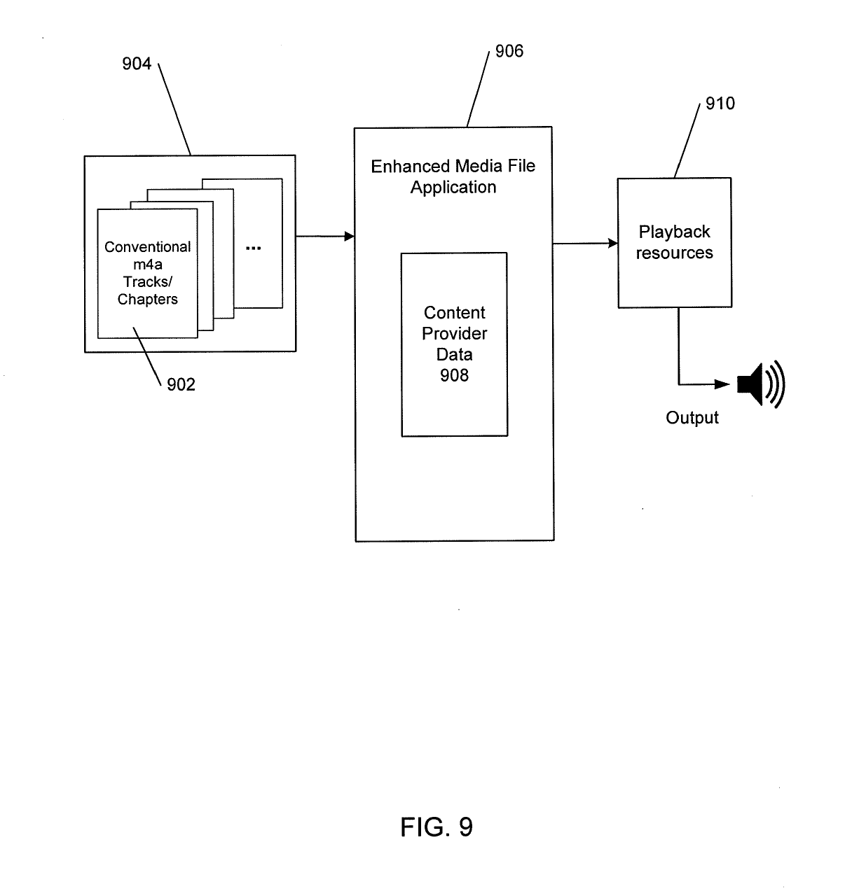

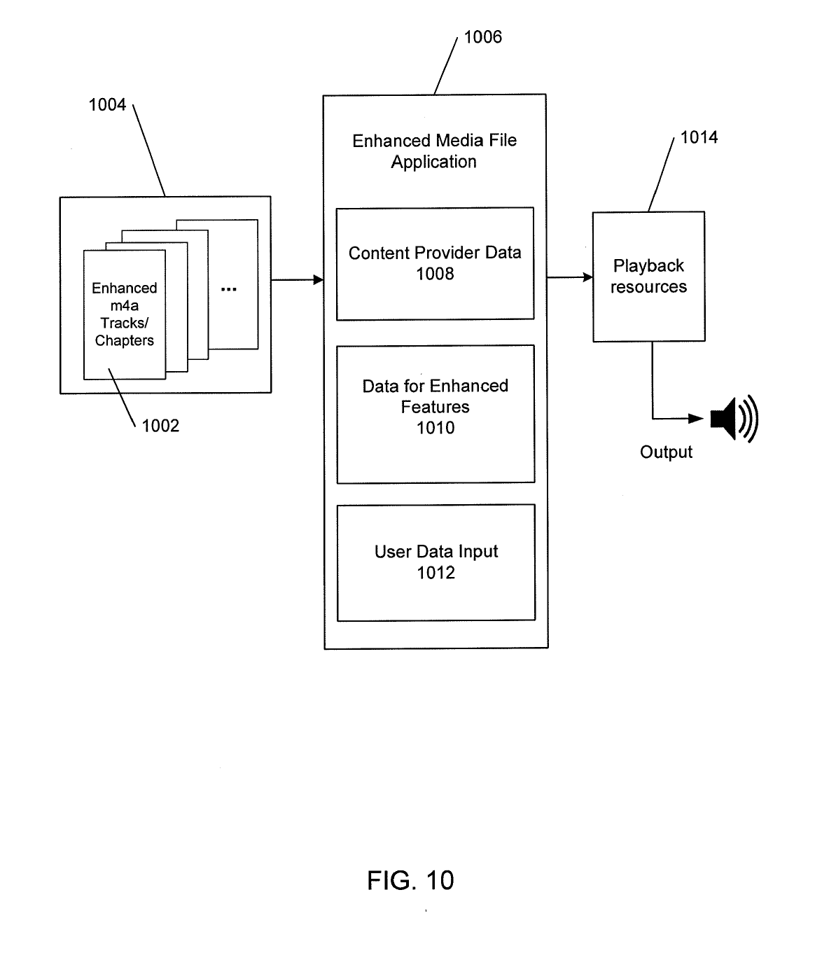

As noted above, the enhanced media file disclosed herein in backwards-compatible with conventional media players, a feature that is emphasized by the conventional file name suffix (i.e., m4a) that is utilized by the enhanced media file. In addition, the enhanced media file application is capable of processing both enhanced media files and conventional files with recorded programming. The drawings illustrate this flexibility. FIG. 8 shows playback of an enhanced media file using a conventional media player, FIG. 9 shows playback of a conventional media file with the enhanced media file application, and FIG. 10 shows processing of an enhanced media file with the enhanced media file application.

FIG. 8 is a block diagram that illustrates playback of an enhanced media file 802 from a media file library collection 804 by a conventional media player 806. As noted above, when an enhanced media file 802 is provided to the conventional media player 806, the player will automatically extract data comprising media tracks, such as audio and video tracks, in accordance with data formats that the player recognizes. Such recognized data formats may typically include, for example, file formats associated with a recognized file name suffix. The extracted data will include data for the conventional recorded programming portions of the enhanced media file, data including content data of the content provider and data such as artist information, title information, music genre, album artwork, lyrics, and the like. Such extracted data is represented in FIG. 8 by the Content Provider Data box 808. The extracted data for the conventional recorded programming of the enhanced media file 802 is processed by the conventional media player 806 for playback through playback resources 810, resulting in audio and/or video output. As noted above, the playback resources may include system resources of the host device as accessed through the operating system of the host device, as well as any resources of the media player.

FIG. 9 is a block diagram that illustrates playback of a conventional media file 902 from a media file library collection 904 by an enhanced media file application 906. When a conventional recorded programming media file 902 is provided to the enhanced media file application 906, the application will automatically extract data comprising media tracks, such as audio and video tracks, in accordance with data formats that the application recognizes. Such recognized data formats may typically include, for example, file formats associated with a recognized file name suffix. In the example described thus far, the “m4a” suffix is utilized. As noted above, the application 906 may be configured to recognize other file name suffixes. The extracted data will include data for the conventional recorded programming, such as the audio and video stems of the conventional media file, or track. The extracted data will also include content data of the content provider, such as artist information, title information, music genre, album artwork, lyrics, and the like. Such extracted data is represented in FIG. 9 by the Content Provider Data box 908. The extracted data for the conventional recorded programming of the conventional media file 902 is processed by the enhanced media file application 906 for playback through playback resources 910, resulting in audio and/or video output. As noted above, the playback resources may include system resources of the host device as accessed through the operating system of the host device, as well as any resources of the enhanced media file application and any other resources available through the host device.

FIG. 10 is a block diagram that illustrates processing of an enhanced media file 1002 from a media file collection 1004 by an enhanced media file application 1006. When an enhanced media file 1002 is provided to the enhanced media file application 1006, the application will automatically extract data comprising media tracks, such as audio and video stems, in accordance with data formats that the application recognizes. Such recognized data formats may typically include, for example, file formats associated with a recognized file name suffix. In the example described thus far, the “m4a” suffix is utilized. As noted above, the enhanced media file application 1006 may be configured to recognize other file name suffixes. The extracted data will include data for the conventional recorded programming, such as the audio and video stems of the conventional media file, or track. The extracted data will also include content data of the content provider, such as artist information, title information, music genre, album artwork, lyrics, and the like. Such extracted data is represented in FIG. 10 by the Content Provider Data box 1008. The extracted data will also include data for the enhanced features, such as vocal and audio stems (to the extent that they are not provided by the conventional recorded programming or are different from those provided by the conventional recorded programming), Configuration File and Automation File data, MIDI information, pitch and timing information for the track information screen (FIG. 5), and other enhanced features supported by the enhanced media file. The pitch information and timing information of the FIG. 5 track information screen 502 are used for ensuring that the depicted musical note indicators 508 and lyrics 510 appear at the proper location with respect to the elapsed time of the corresponding album track or movie chapter. The extracted data for the enhanced features is represented in FIG. 10 by the Data for Enhanced Features box 1010.

As noted above, the enhanced media file application supports storing user data input with the enhanced media file. The user data input may comprise, for example, settings entered through the track menu screen (FIG. 2). Thus, the user data input is both read from and written to the enhanced media file 1002. Such user data input is represented in FIG. 10 by the User Data Input box 1012. The extracted data from the enhanced media file is processed by the enhanced media file application 1006 for playback through playback resources 1014, resulting in audio and/or video output. As noted above, the playback resources may include system resources of the host device as accessed through the operating system of the host device, as well as any resources of the enhanced media file application and any other resources available through the host device.

For the exemplary system of FIG. 10, in addition to the standard information generally available about any album track, such as the content provider information, the music library 1004 can provide metadata from any requested album track from the music library to an application, such as the suitably configured enhanced media file application 1006. The application can then examine the metadata for any user-supplied data in addition to standard information such as song title, artist, and the like. The examination of user supplied data is indicated in FIG. 10 by the User Data Input box 1012 within the enhanced media file application 1006. For the example m4a system described herein, as noted above, the user-supplied data provides the uuid boxes that are marked with the selected ID indicator “maap” for providing the enhanced features. The contents of the uuid boxes can then be accessed by the enhanced media file application to extract descriptive information about the track contents as well as any binary data supplied for the enhanced features. In accordance with the description herein, the data payload in the uuid boxes is used to carry the additional information on enhanced features described previously. The appended enhanced feature data is automatically detected and extracted by the enhanced media file application 1006, and is deposited into temporary files to be used with the enhanced feature processing, such as for gaming entertainment or interactive listening.

Because the user-supplied data is so marked, the enhanced media file application 1006 alerts the user to its presence and provides value-added interaction with the musical content. This may include, for example, scenarios such as remixing of commercial tracks, added audio effects for some or all tracks, audio effects applied to user supplied music by way of a microphone or synthesized audio, or gaming contexts such as karaoke. For example, some remixing and level controls for the supplied audio can be supported as enhanced features, as well as voice enhancements for the user. These additional controls are exposed to the user after the enhanced features playback application determines their existence. Furthermore, a second screen can be produced and made available for the karaoke gaming context that is included along with the additional audio and enhanced features files. This second screen becomes available when the application determines that they are optionally included in the master “iTunes” m4a file.

As noted above, the enhanced features may include, for example, selection of vocals only or instruments only from an enhanced media file, or the enhanced features may include karaoke functions that dub a user's voice into a recording or that replace recorded vocals with the user's vocals, or may include game applications integrated into tracks and channels of the enhanced media file, and the like. Other features and content can be added. For example, additional content can be created using collaborative music tools such as are available from MuseAmi, Inc., the assignee of the present invention. Using such collaborative tools, a user can initially create content through participatory interaction with the enhanced feature data described above, such as the “maap” file noted previously for an m4a file, and then the user can provide the created content to an appropriate portal (or other means of distribution and collaboration), whereupon additional users may further add to or collaborate with the content generated by the first user. This process can be continuous and iterative with additional users.

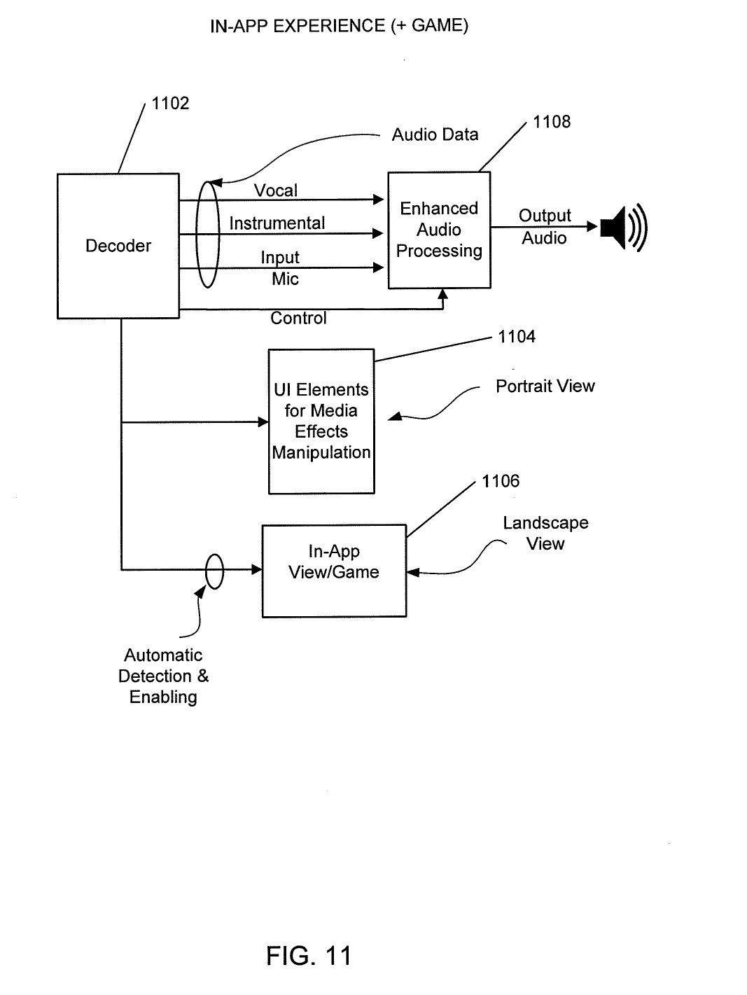

FIG. 11 illustrates processing of an enhanced media file during playback and shows the enhanced user features that are available during playback of the enhanced media file. A decoder 1102 is a component of the enhanced media file application 1006 (FIG. 10) that receives an enhanced media file as input, and also may receive a stored media effects file, may receive a stored user data input file, and may receive a real-time interactive user contribution such as a microphone input or control settings. The decoder 1102 is the means by which a user gains access to feature data in an enhanced media file. The decoder may be integrated with the execution of the enhanced media file application, so that the execution of the decoder is automatic and transparent to the user. For example, referring to FIG. 7, the decoder will read, or decode, the vocal stems 714 and instrumental stems 716 of the enhanced media file, and will process additional metadata 718, 720, 722, 724 of the enhanced media file, as well as process the real-time user data input and control settings, comprising the feature data.

The enhanced user features provided by the feature data may be responsive to movement and orientation of the playback device. For example, one set of features 1104 such as user interface elements may be provided when the device is held in portrait view, and another set of features 1106 such as in-application viewing or a game may be provided when the device is held in landscape view, as indicated in FIG. 11. The audio processing block 1108 comprises the processing illustrated in FIG. 10, which is indicated by the content provider block 1008, data for enhanced features block 1010, and user data input 1012. The audio processing block may include processing by both the enhanced media file application 804 and resources of the host device, accessed through the operating system of the host device. The processing may include processing of vocal track data, instrumental track data, and input from a microphone, as described above. The processing may also include processing of user input such as control input received via the user interface screens illustrated above in FIGS. 2-6.

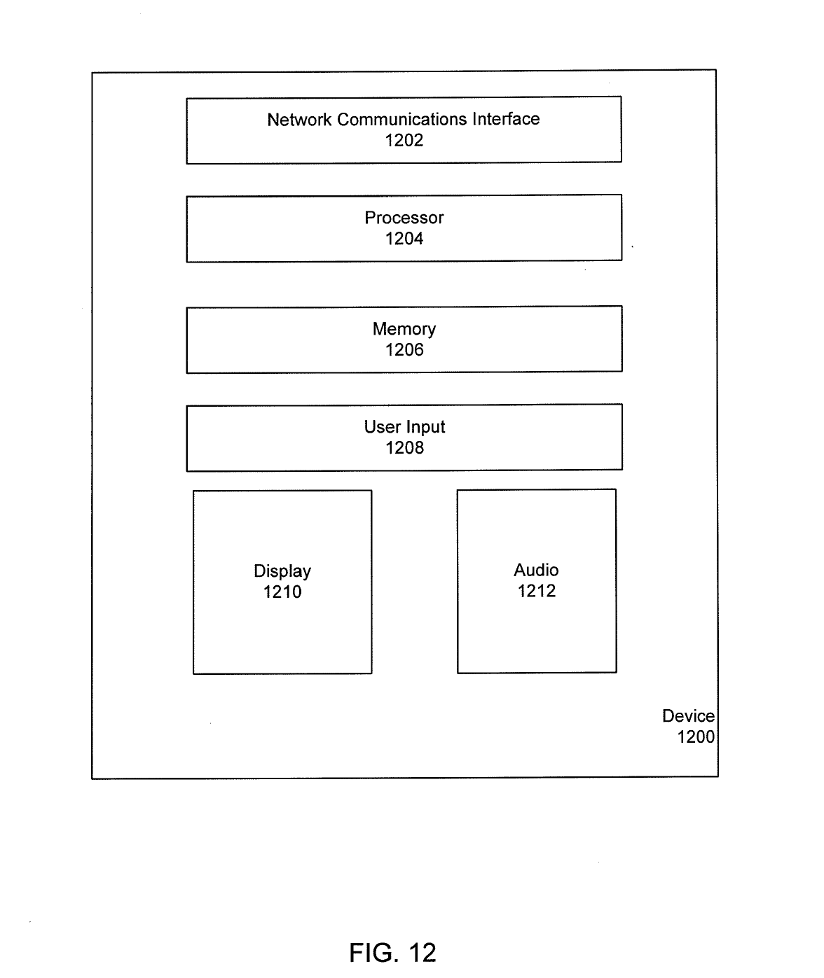

FIG. 12 is a block diagram of a host device 1200 with a suitably configured enhanced media file application for the enhanced features described herein. For example, the enhanced media file application may be installed on the device 1200 for support of the enhanced features during processing of the enhanced media file. The file creation and editor application for use with the creation process illustrated in FIG. 7, such as the “atomicparsely” tool, may be installed on the device 1200 for production of the enhanced media file. Thus, the host device 1200 may comprise a mobile platform computer device such as a laptop or tablet computer device or may comprise a desktop computer device, or one of a variety of computer devices with similar capabilities.

The host device 1200 includes a network communications interface 1202 through which the device communicates with a network and/or other users. For example, the interface 1202 may comprise a component for communication over “WiFi” networks, cellular telephone networks, the “Bluetooth” protocol, and the like. A processor 1204 controls operations of the host device. The processor comprises computer processing circuitry and is typically implemented as one or more integrated circuit chips and associated components. The device includes a memory 1206, into which the device operating system, enhanced media file application, user data, and machine-executable program instructions can be stored for execution by the processor. The memory can include firmware, random access memory (RAM), and storage media. A user input component 1208 is the mechanism through which a user can provide controls and data. The user input component can comprise, for example, a touchscreen, a keyboard or numeric pad, vocal input interface, or other input mechanism for providing user control and data input to operate the enhanced media file application. A display 1210 provides visual (graphic) output display and an audio component 1212 provides audible output for the host device. It should be understood that a wide variety of devices are suitable for execution of the enhanced media file application described herein. Moreover, those skilled in the art will understand that a similarly wide variety of devices are suitable for creating content to be incorporated into enhanced media files with data that are executed by the processor to provide the enhanced features described herein.

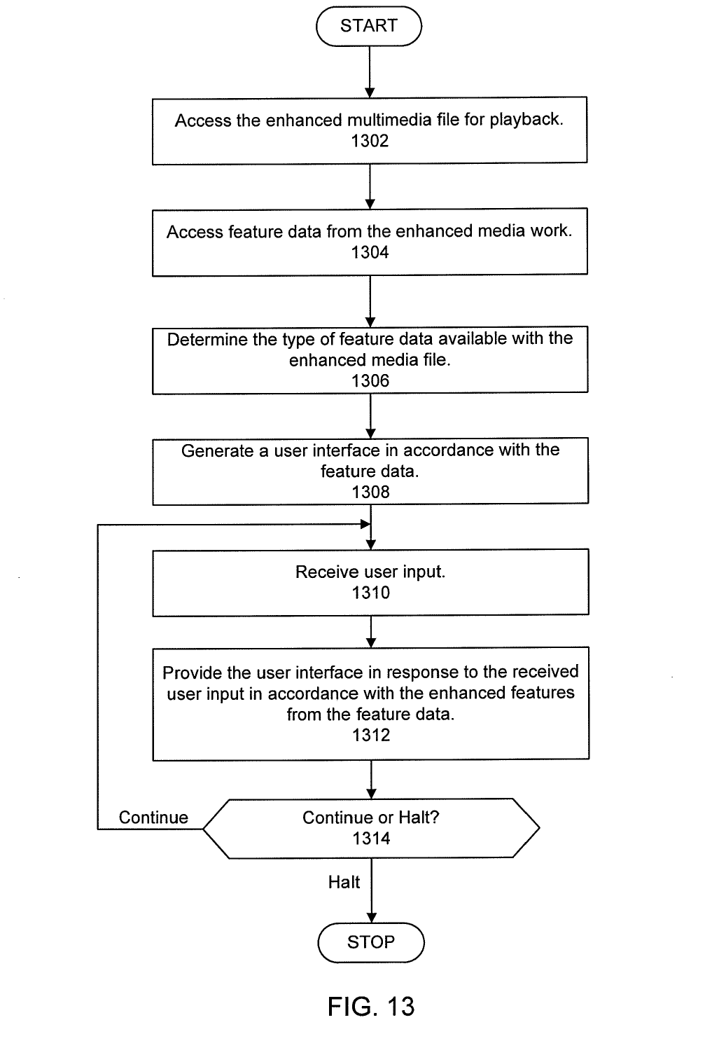

FIG. 13 is a flow diagram of device operations for providing the enhanced features in conjunction with processing of an enhanced media file as discussed herein. The operations may be performed by a host device such as the device 1000 illustrated in FIG. 10. In the first device operation, indicated by the flow diagram box labeled 1302, the enhanced media file application of the host device accesses the enhanced media file, which may be stored at the host device or at an external device connected to the host, or may be streamed or otherwise obtained from another device via a network connection. At box 1304, the enhanced media file application accesses feature data that is read from the enhanced media file. This operation is achieved by the application parsing the enhanced media file and recognizing the metadata associated with the enhanced media file, such as finding the data in the udta section associated with the map data of the m4a file. In the next operation, indicated by the next box 1306, the enhanced media file application determines the feature data that is available in the file and determines the enhanced features that are possible from the feature data. At box 1308, the enhanced media file application generates a user interface in accordance with the feature data of the enhanced media file. This operation exposes the controls and user interface features in accordance with the feature data. The features may comprise, for example, the screen displays illustrated in FIGS. 2-6. The enhanced media file application is now ready to receive user interaction for initiating and manipulating the user interface with the enhanced features.

At the next box 1310, the device receives user input for the enhanced features via the user interface. The user input may comprise, for example, user vocal input, touchscreen input, keyboard data, and the like, as initiated by the user. The user input is processed by the enhanced media file application. At box 1312, the enhanced media file application generates the user interface in response to the received user input, in accordance with the enhanced features. As noted above, it is possible to store any interaction provided by the user, such as settings and user input, and it is possible to modify the audio and visual presentation in response to the user input. All of this processing for storing user input and responding to user input is encompassed within the operation represented by the box 1312. In this way, the user can enjoy the enhanced features that are available through the user interface from an enhanced media file with the feature data described herein, as processed by the suitably configured enhanced media file application of the host device. As noted above, a conventional playback application that processes the enhanced media file will not be able to access the feature data and therefore will not be able to provide the enhanced features, and will instead provide a conventional playback experience. The enhanced media file application continues to process user input at the box 1314, for as long as the user provides input, or the application halts processing upon termination.

The enhanced media file may be provided as a computer program product embodied in a non-transitory computer readable storage medium containing computer implementable instructions that may be executed by a computer device. The storage medium may comprise, for example, flash memory, an optical disc such as data CD or DVD, or other data storage device. The computer device for executing the enhanced media file may comprise a wide variety of computer devices that operate under control of a processor, such as, for example, a mobile device or table computer or desktop or laptop computer. The computer implementable instructions stored on the storage medium comprise data of a media file that is configured for playback with a playback application and feature data associated with the media file data. The feature data is configured for playback with an enhanced playback application, and the stored media file data and the associated stored feature data comprise the enhanced media file such that the playback application can process the media file data for playback but cannot process the feature data. The enhanced playback application can process the media file data and can process the feature data

It will be appreciated that many additional processing capabilities are possible, according to the description herein. Further, it should be noted that the methods, systems, and devices discussed above are intended merely to be examples. Various embodiments may omit, substitute, or add various procedures or components as appropriate. For instance, it should be appreciated that, in alternative embodiments, the methods may be performed in an order different from that described, and various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments. Further, the headings provided herein are intended merely to aid in the clarity of the descriptions of various embodiments, and should not be construed as limiting the scope of the invention or the functionality of any part of the invention. For example, certain methods or components may be implemented as part of other methods or components, even though they are described under different headings.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figures.

What is claimed is:

1. A method of processing an enhanced media file at a computer device, the method comprising:
accessing enhanced feature data of the enhanced media file at the computer device;
generating a user interface in accordance with the accessed enhanced feature data;
receiving user data input from the user interface for applying to the enhanced feature data;
storing the received user data input with the enhanced feature data of the enhanced media file;
wherein the enhanced feature data can be processed by an enhanced media file application installed at the computer device but is ignored by a conventional playback application installed at the computer device.

2. The method as in claim 1, the method further including:
retrieving the stored user data input;
processing the retrieved user data input by the enhanced media file application for output by the computer device.

3. The method as in claim 1, wherein storing the received user data input comprises recording the received user data input in metadata of the enhanced media file.

4. The method as in claim 1, wherein the received user data input specifies a real-time media effect that alters output of the enhanced media file application.

5. The method as in claim 4, wherein the real-time media effect relates to an audio change during processing of the enhanced media file.

6. The method as in claim 5, wherein the audio change relates to an audio stem of the enhanced media file.

7. The method as in claim 5, wherein the audio change relates to a stored user data input.

8. The method as in claim 5, wherein the audio change relates to user data input received during processing of the enhanced media file and alters output of the enhanced media file application.

9. The method as in claim 8, wherein the received user data input comprises settings for the real-time media effects.

10. The method as in claim 8, wherein the received user data input comprises data from an audio capture device.

11. The method as in claim 4, wherein the real-time media effect relates to a video change during processing of the enhanced media file.

12. The method as in claim 1, wherein storing the received user data input comprises overwriting a prior user data input.

13. The method as in claim 1, wherein storing the received user data input comprises appending the received user data input to the enhanced feature data.

14. A computer device for processing an enhanced media file, the computer device comprising:
a processor configured to execute program instructions;
program instructions stored in the computer device that, when executed by the processor, provide operations that access enhanced feature data of the enhanced media file at the computer device, generate a user interface in accordance with the accessed enhanced feature data, receive user data input for applying to the enhanced feature data, and store the received user data input with the enhanced feature data of the enhanced media file;
wherein the enhanced feature data can be processed by an enhanced media file application installed at the computer device but is ignored by a conventional playback application installed at the computer device.

15. The computer device as in claim 14, wherein the processor further provides operations that retrieve the stored user data input and process the retrieved user data input for output by the computer device.

16. The computer device as in claim 14, wherein the received user data input is recorded in metadata of the enhanced media file.

17. The computer device as in claim 14, wherein the received user data input specifies a real-time media effect that alters output of the enhanced media file application.

18. The computer device as in claim 17, wherein the real-time media effect relates to an audio change during processing of the enhanced media file.

19. The computer device as in claim 18, wherein the audio change relates to an audio stem of the enhanced media file.

20. The computer device as in claim 18, wherein the audio change relates to a stored user data input.

21. The computer device as in claim 18, wherein the audio change relates to user data input received during processing of the enhanced media file and alters output of the enhanced media file application.

22. The computer device as in claim 21, wherein received user data input comprises settings for the real-time media effects.

23. The computer device as in claim 21, wherein the received user data input comprises data from an audio capture device.

24. The computer device as in claim 17, wherein the real-time media effect relates to a video change during processing of the enhanced media file.

25. The computer device as in claim 14, wherein storing the received user data input comprises overwriting a prior user data input.

26. The method as in claim 14, wherein storing the received user data input comprises appending the received user data input to the enhanced feature data.

27. A method of producing an enhanced media file at a computer device, the method comprising:
storing data of a media file at the computer device, the stored media data file comprising data that is configured for playback with a conventional media playback application;
storing enhanced feature data associated with the media file data at the computer device, the enhanced feature data configured for playback with an enhanced media file application;
wherein the stored media file data and the associated stored enhanced feature data comprise the enhanced media file such that the enhanced media file application can process the enhanced media file and access enhanced feature data of the enhanced media file, generate a user interface in accordance with the accessed enhanced feature data, receive user data input for applying to the enhanced feature data, and store the received user data input with the enhanced feature data of the enhanced media file;
wherein the enhanced feature data can be processed by the enhanced media file application but is ignored by a conventional playback application.

28. A method of configuring a computer host device, the method comprising:
establishing a network communication link at a server computer device to the computer host device;
transmitting program instructions from the server computer device to the computer host device over the network communication link, wherein the transmitted program instructions are configured to be stored in memory of the computer host device and executed to access enhanced feature data of an enhanced media file at the computer host device, generate a user interface in accordance with the accessed enhanced feature data, receive user data input for applying to the enhanced feature data, and store the received user data input with the enhanced feature data of the enhanced media file;
wherein the enhanced feature data can be processed by an enhanced media file application installed at the computer host device but is ignored by a conventional playback application installed at the computer host device.

29. A computer program product embodied in a non-transitory computer readable storage medium containing computer implementable instructions executed by a computer device, the computer implementable instructions comprising data of a media file that is configured for playback with a playback application and enhanced feature data associated with the media file data, wherein the enhanced feature data is configured for playback with an enhanced playback application, and wherein the stored media file data and the associated stored feature data comprise the enhanced media file such that the playback application can process the media file data for playback but cannot process enhanced the feature data, and such that the enhanced playback application can process the media file data and can process the enhanced feature data.
